(19) United States
(12) Patent Application Publication
(10) Pub. No.: US 2008/0245236 A1
(43) Pub. Date: Oct. 9, 2008

(54) SYSTEM COMPRISING A BEVERAGE MACHINE AND COMPRISING PORTION CAPSULES

(75) Inventors: Rudiger Ternite, Hamburg (DE); Werner Balkau, Schwandi (CH); Hartwig Meyer-Ruhstrat, Stelle (DE); Ingo Lantz, Hamburg (DE)

Correspondence Address: HOVEY WILLIAMS LLP, 10801 Mastin Blvd., Suite 1000, Overland Park, KS, 66210, US

(73) Assignee: TCHIBO GMBH, Hamburg (DE)

(21) Appl. No.: 12/058,549

(22) Filed: Mar. 28, 2008

(30) Foreign Application Priority Data
Mar. 29, 2007 (EP) 07006600.6

(51) Int. Cl. A47J 31/00; A23L 2/00

(52) U.S. Cl. 99/295; 426/590

(57) ABSTRACT

In a system comprising a beverage machine and comprising portion capsules of at least two different types which each contain a beverage substance, portion capsules of different types are provided with colour codings which differ from one another. The beverage machine is designed to prepare beverages, in particular to brew hot coffee beverages, by means of the portion capsules and has a pressurized-water device, a capsule holder which is provided to accommodate a portion capsule, and a control means. The beverage machine also contains a colour-identification device which is designed to detect the colour coding of a portion capsule which is to be or is inserted into the capsule holder and to select a program, in the control means, for operating the beverage machine, which program is associated with this colour coding.

### RELATED APPLICATION

This Application claims priority of European Application Serial No. 07006600.6, filed Mar. 29, 2007, which is hereby incorporated in its entirety by reference herein.

### BACKGROUND

1. Field

The invention relates to a system comprising a beverage machine and comprising portion capsules (cartridges) of at least two different types, to a beverage machine which is designed to prepare beverages, in particular to brew hot coffee beverages, and also to a method for preparing a beverage.

2. Discussion of Prior Art

DE 10 2004 056 224 A1 discloses a system comprising a coffee machine and a portion capsule, with which system beverages can be produced from extractable substances, for example coffee. This coffee machine has a pressurized-water device, a portion-capsule holder and a control means. When or after a portion capsule is inserted into the portion-capsule holder, the cover and the base of the portion capsule are pierced by two piercing means which can move in relation to one another, so that hot water can pass into the interior of the portion capsule through the capsule cover and beverage can pass out of the portion capsule through the capsule base. In the system already known, the control means is designed to provide at least three different pressures for the pressurized water, for example for brewing espresso (for example 13 bar to 18 bar or 8 bar to 18 bar), café crema (for example 9 bar to 13 bar or 4 bar to 10 bar) and filter coffee (for example 3 bar to 9 bar or 1 bar to 4 bar). The portion capsules provided for the different pressure stages are of different design in this case. Therefore, by way of example, the portion capsule for the lowest pressure stage has a predetermined weakened point in the base, whereas the portion capsules for high pressures have a base which is not weakened. The brewing pressures prespecified by means of the control means of the coffee machine are matched to the contents of the respective portion capsule and adapted to the coffee beverage to be brewed with the said portion capsule.

The system according to DE 10 2004 056 224 A1 is sold with portion capsules which permit simple association of the respective capsule design with the pressure stage, which is intended for brewing, of the coffee machine. To this end, the portion capsules are coloured on the capsule base and the capsule wall, for example blue for the lowest pressure stage (filter coffee) and black for the highest pressure stage (espresso). The brewing keys of the coffee machine are accordingly identified by the same colours, with each brewing key having an unambiguously associated pressure stage of the control means of the coffee machine. The user can therefore unambiguously identify which capsule should be brewed with which pressure and which function key of the coffee machine is to be operated for this purpose.

However, one disadvantage of this embodiment is that the respective pressure stage has to be explicitly selected by the user. There is therefore a risk of mistakes, for example by the user selecting the high-pressure stage of the coffee machine when a portion capsule for a low pressure is inserted.

WO 2005/079638 A1 describes a portion-capsule whose cover is provided with an RFID (“Radio Frequency IDentification” chip) or a barcode. When the portion-capsule is inserted into a brewing machine which is equipped with a suitable RFID- or barcode-reading device, the information contained in the RFID or barcode can be used to control the brewing machine. In addition to the relatively high outlay required for RFID- or barcode-reading devices, they have the disadvantage that reliable functioning is not ensured under conditions which prevail in brewing or beverage machines, for example with a view to soiling.

### SUMMARY

The object of the invention is to provide a system comprising a beverage machine and comprising portion capsules of at least two different types, in which system the portion capsule used is automatically identified, and which system is of simple construction and functions in a reliable manner.

This object is achieved by a system according to claim 1 and also a corresponding beverage machine according to claim 16. Claim 18 defines a method for preparing a beverage. Advantageous refinements of the invention can be found in the subclaims.

The system according to the invention has a beverage machine and also portion capsules of at least two different types, which portion capsules each contain a beverage substance. The beverage machine is designed to prepare beverages, in particular to brew hot coffee beverages, by means of portion capsules and has a pressurized-water device, a capsule holder (for example a brewing chamber) which is designed to accommodate a portion capsule, and a control means. Portion capsules of different types are provided with colour codings which differ from one another. The beverage machine is equipped with a colour-identification device which is designed to detect the colour coding of a portion capsule which is to be or is inserted into the capsule holder and to select a program, which is associated with this colour coding, for operating the beverage machine in the control means.

The term “operation” is to be understood in an entirely general manner here. In particular, running of a program for operating the beverage machine may also involve blocking use of the beverage machine with the portion capsule just detected or not permit running with this portion capsule.

A colour coding is to be understood as an identifier of the respective portion capsule which can be detected by the colour-identification device of the beverage machine. In this case, it is the colour as such which is applied, for example, in a predetermined region of the portion capsule. In this case, a barcode in the form of coloured strips, for example, does not fall within the meaning of the term “colour coding”.

A colour can be reliably selected from a prespecified colour palette by means of low-cost commercially available colour-identification devices. This is true particularly when the number of colours or colour codings for the different types of portion capsules is relatively low, this being the case in practice due to the limited number of portion-capsule types. Because of this, colour deviations which actually occur (for example due to nuances in the colour coding of a specific type of portion capsule or due to soiling) or which are based on faults in the colour-identification device, can then be ignored without problems.

The colour identification device can have a colour sensor. The colour-identification device can also have a light source which is separate from the colour sensor and/or a light source which is integrated in the colour sensor. The colour coding is illuminated, for example with white light, by means of the light source. The colour sensor detects the light which is reflected by the colour coding and whose spectral composition corresponds to the colour of the colour coding. The colour sensor contains, for example, three separate sensors which are matched to the three primary colours, for example by means of a respective preset colour filter. Colour sensors of this type are known. They are connected to control and evaluation electronics.

When a portion capsule is inserted into the beverage machine, the light source can be switched on for a brief time, for example by means of a microswitch, during which time the colour sensor identifies the colour of the colour coding of the portion capsule and forwards it, for example as a digital signal, to the control means of the beverage machine. It is also feasible for the light source to be switched on and the colour coding of the portion capsule to be detected when the user presses a start button in order to trigger the beverage-preparation process.

During operation of the beverage machine, the control means executes a program which is associated with the colour coding of the inserted portion capsule. The water pressure, the water temperature, the water quantity or the throughflow rate of the water used for preparation purposes, for example, can be controlled during running of this program. It is also possible to vary specific variable values, that is to say to not keep the said variable values constant, during preparation. Brief interruption of a brewing process allows, for example, the extraction behaviour of extractable substances to be improved.

In one embodiment of the invention, the control means of the beverage machine is designed to carry out a first step of a beverage-preparation process in accordance with the program selected by means of the colour coding of a first portion capsule and to carry out a second step of the beverage-preparation process in accordance with the colour coding of a second portion capsule which is accommodated in the capsule holder after said first portion capsule. An example of this is the brewing of cappuccino using two portion capsules. In this case, a portion capsule containing ground coffee is first inserted into the capsule holder. The colour-identification device detects its colour coding and controls the beverage machine, for example by means of a pressure which is in the medium pressure range. The empty portion capsule is then removed and replaced by a portion capsule of another type which contains, for example, milk powder. The colour-identification device also detects the colour coding of this portion capsule and selects a corresponding program of the control means, for example a program which matches the water quantity to the milk-powder quantity. In this example, the program sequence in the beverage machine can be preselected such that a specific colour coding for the second portion capsule is expected as early as after the identification of the colour coding of the first portion capsule (that is to say the portion capsule containing the ground coffee for cappuccino). If the colour coding detected from the second portion capsule deviates from this, a fault signal may be triggered, for example.

The system according to the invention also permits complex program sequences to be associated with a predefined colour coding.

The system can be used for preparing hot beverages or for preparing cold beverages. Systems according to invention which can prepare both hot and cold beverages are likewise feasible; systems of this type can prepare, for example, a cold beverage by virtue of a heating device which is present not being heated up.

In advantageous refinements, portion capsules of different types are in each case closed on all sides in the delivery state, and they have a capsule body with a capsule base and a side wall and also a capsule cover which is fixed to the capsule body. In this case, the capsule body of the portion capsules of different types can have a circumferential, outwardly projecting flange, to which the capsule cover is fixed, on its outer end. The colour codings of portion capsules of different types can have a different colouring on the respective capsule bodies, it being possible to achieve this, for example, by completely colouring plastic materials used for the capsule bodies. In addition or as an alternative to this, the colour codings of portion capsules of different types can have different colourings and/or colour codes on the respective capsule covers. Examples of this are a coloured dot, a uniform coat of colour in the capsule cover or a base colour of the capsule cover which is additionally provided with a label.

When the colour coding is provided on the capsule body, the light source of the colour-identification device should shine on the capsule body and therefore be arranged on the capsule holder, for example to the side of the capsule body. The same applies to the position of the colour sensor. In the case of colour codings on the capsule cover, the light source should illuminate the capsule cover and the colour sensor should be positioned such that it detects the reflection from the capsule cover. The use of a plurality of colour sensors and/or light sources is likewise feasible. Optical elements such as lenses, reflectors or light guides can also be used in order to influence the beam path.

Otherwise, the portion capsules and the capsule holder of the beverage machine can be constructed in a similar manner to that known from DE 10 2004 056 224 A1 in advantageous embodiments. The capsule base can therefore have a predetermined weakened point, in particular in portion capsules for low preparation pressures which are filled, for example, with filter coffee, in order to facilitate opening of the portion-capsule at the beginning of the preparation process. The capsule holder can have two associated piercing means which can move in relation to one another and are designed to pierce the capsule cover and the capsule base when or after a portion capsule is inserted into the capsule holder, so that water can pass into the capsule body through the capsule cover and beverage can pass out of the capsule body through the capsule base. The capsule holder can have a portion-capsule holding device which can be removed from the rest of the beverage machine, it being possible for the beverage machine to have a movable holding device which is designed to accommodate the portion-capsule holding device and by means of which the portion-capsule holding device can be moved towards a stationary abutment face and can be moved away from the abutment face. A portion capsule of at least one type can contain a distributor device above the beverage substance and/or a screening device beneath the beverage substance, in order to ensure uniform distribution of the preparation water and/or a filter effect for the prepared beverage. The screening device can also be used as a collection device which permits the prepared beverage to flow out of the portion capsule unimpeded.

Suitable beverage substances with which a portion-capsule is filled are, for example, particulate and water-extractable beverage substances such as ground coffee, in particular ground coffee for filter coffee, ground coffee for café crema, ground coffee for espresso or decaffeinated ground coffee, but also instant coffee, tea, milk powder, cocoa powder, instant soup, sugar, sweetener, liquid milk, liquid milk concentrate, fruit concentrate etc.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 shows a schematic illustration of an arrangement of a portion capsulewith a light source and a colour sensor, with the light source and the colour sensor detecting the capsule cover, specifically in a side view in part (a) and in a three-dimensional view in part (b),

FIG. 2 shows a schematic illustration of an arrangement of a portion capsule with a light source and a colour sensor, with the light source and the colour sensor detecting the capsule side wall, specifically in a side view in part (a) and in a three-dimensional view in part (b),

FIG. 3 shows a schematic illustration (with a water-flow plan) of a coffee machine of the system according to the invention,

FIG. 4 shows a longitudinal section through one embodiment of the portion-capsule holder of the coffee machine with portion capsule inserted, in the starting position,

FIG. 5 shows a longitudinal section similar to that in FIG. 4, but once the portion-capsule holder has been moved into the brewing position, and

FIG. 6 shows a schematic longitudinal section through the portion capsule of the system according to the invention.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENT

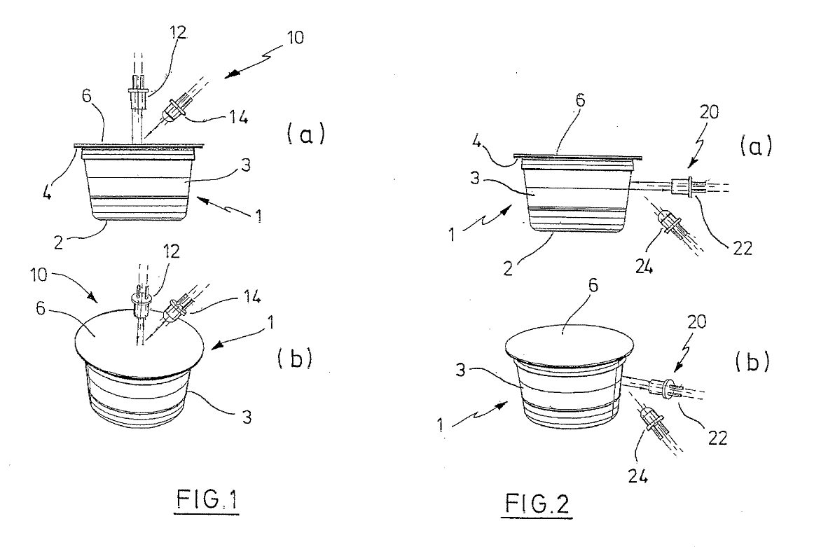

FIGS. 1 and 2 illustrate a portion capsule 1 which contains a beverage substance. In the exemplary embodiments, the portion capsule 1 is closed on all sides in the delivery state and has a capsule body with a capsule base 2 and a side wall 3. A circumferential flange 4 projects outwards at the upper end of the side wall 3. In the exemplary embodiments, the capsule base 2, the side wall 3 and the flange 4 are integrally formed as an injection-moulded part or as a thermoformed part from a food-grade plastic which can be made up of one or more layers. A capsule cover 6 comprising an aluminium foil is sealed onto the flange 4 from above.

The capsule base 2 can be provided with a predetermined weakened point. In its interior, the portion capsule can have a distributor device above the beverage substance and/or a screening device or collection device beneath the beverage substance. Examples of these can be found in DE 10 2004 056 224 A1.

In the exemplary embodiment, eight different types of portion capsule 1 are provided, namely
a portion capsule, which is filled with ground coffee for filter coffee as the beverage substance, for a low brewing pressure and with a predetermined weakened point on the capsule base and relatively large openings in a screening or filter device beneath the beverage substance and above the capsule base,
a portion capsule, which is filled with ground coffee for café crema as the beverage substance, for a medium brewing pressure and with a predetermined weakened point on the capsule base and a screening or filter device with relatively small openings beneath the beverage substance and above the capsule base,
a portion capsule, which is filled with ground coffee for espresso as the beverage substance, for a high brewing pressure and with a base which is not weakened and a filter device beneath the beverage substance and above the capsule base,
a portion capsule which is filled with liquid milk concentrate as the beverage substance,
a portion capsule which is filled with liquid cocoa concentrate as the beverage substance,
a portion capsule which is filled with soluble milk powder as the beverage substance,
a portion capsule which is filled with tea leaves as the beverage substance, and
a portion capsules, which are filled with soluble or largely soluble fruit concentrate as the beverage substance, for preparing fruit juice using cold water with a low preparation pressure.

The portion capsules 1 of different types have the same outer shape in the exemplary embodiment, but they differ by virtue of the presence or absence of a predetermined weakened point on the capsule base 2 and by virtue of internal components which are not illustrated in the figures.

Furthermore, the portion capsules 1 of different types are provided with colour codings which differ from one another. In the exemplary embodiment according to FIG. 1, the capsule covers 6 have base colours which are considerably different from one another (and are provide with a label over the base colour, in order to identify the type of portion capsule). In the exemplary embodiment according to FIG. 2, the capsule bodies (with capsule base 2, side wall 3 and flange 4) are uniformly coloured using significantly different colours.

The colour coding of the portion capsules 1 can be detected by a colour-identification device of a beverage (e.g., coffee) machine A, in order to operate the beverage machine in accordance with a program which is associated with this colour coding.

In the exemplary embodiment according to FIG. 1, a colour-identification device 10 which is arranged above the capsule cover 6 has a colour sensor 12 and a light source 14. The light source 14 illuminates the capsule cover 6 from above, and the colour sensor 12 detects the reflected light and uses associated electronics, which are not illustrated in the figures, to identify the colour coding or the colour range and emits a signal, preferably a digital signal, as an output signal, possibly via the associated electronics, with which signal a program for operating the beverage machine is unambiguously selected.

According to FIG. 2, a colour-identification device 20 is arranged next to the side wall 3 of the portion capsule, so that a colour sensor 22 can detect the light, which is reflected by the wall 3, of a light source 24.

Colour sensors generally operate on the principle of the human eye. In this case, all colours are described by a mixture of the primary colours red, green and blue. The light source illuminates a coloured surface, preferably with white light. The reflected light from the coloured surface to be identified is broken down into its primary colours, with an intensity signal additionally being produced. Standardizing these values provides distance-independent colour identification. This manner of processing permits virtually all visible coloured surfaces to be identified. The colour value fractions are determined from the reflected radiation and compared with values stored in the associated electronics. If the values correspond or lie within a common range, a corresponding output signal is activated.

The optical spectrum of the light source after it is reflected into the colour sensor from the surface of a body (that is to say the colour coding), combined with the evaluation, is called the colour. The surface of the body absorbs and reflects different fractions of the spectrum, and this is detected by the colour sensor. The electrical output signal for the individual base colours corresponds to the respective intensity of the received light, and the electronics determine a colour value from this. Colour identification is dependent on the colour and the form of the light source, the reflection and absorption properties of the body and also on the sensitivity of the software used for evaluation purposes in the associated electronics.

A colour impression is ultimately subjective. However, in the present case, it is not subjective colour sensitivity that is important but instead unambiguous distinction of the colour codings used for the portion capsules 1. Variants of colour sensors which are not based on the three primary colours red, green and blue but, for example, evaluate the reflected light only in two ranges, are also feasible. There are also various options for the type of evaluation. When only two wavelength ranges are under consideration, the measured values for the two intensities can be divided directly one by the other, for example, in order to obtain a meaningful output signal, this constituting particularly simple standardization. However, in such cases, the colour codings in question also have to be selected such that no ambiguous results are produced.

Commercially available colour sensors generally have three light-sensitive cells for the primary colours red, green and blue. Their electrical signal corresponds to the respective intensity of the received light; the associated electronics determine the colour value from this. In this case, the number of light-sensitive cells and the quality of the signal amplitude decide on how the colour can be assessed in a differentiated manner. In this case, prior calibration to white and to black using the light source provided is advisable.

In the colour-identification devices 10 and 20, the light source 14 or 24 is designed separately from the colour sensor 12 or 22. A light source which is integrated in a colour sensor, even as an additional light source, is likewise feasible.

A beverage machine in which the portion capsule 1 can be used can be of similar construction to the coffee machine (brewing machine) disclosed in DE 10 2004 056 224 A1. The content of this specification and that of the applications or specifications for which the priority has been claimed according to DE 10 2004 056 224 A1, is included in the disclosure content of the present application. U.S. application Ser. No. 11/719,848, filed May 21, 2007, is a National Phase Application pursuant to 37 C.F.R. §371 of International Application No. PCT/EP2005/011666, filed Oct. 31, 2005, which claims priority of German Application No. DE 10 2004 056 224.5, filed Nov. 19, 2004, all of which are hereby incorporated in their entirety by reference herein. If the beverage machine has a central spike for piercing the capsule cover 6, the colour sensor 12 is not arranged along the longitudinal axis of the portion capsule 1, but instead displaced to the side of it, in the exemplary embodiment according to FIG. 1. In this case, the orientation of the light source 14 is matched to the area which is detected by the colour sensor 12.

When the portion capsule 1 is inserted into the capsule holder of the beverage machine (that is to say into the brewing chamber in the exemplary embodiment), or else at a later point in time (for example at the beginning of the brewing process), the colour-identification device 10 or 20 detects the colour coding of the portion capsule 1 and selects a program, which is associated with this colour coding, for operating a beverage machine in the control means of the beverage machine. During running of the program, different variables, for example the water pressure, the water temperature, the water quantity and/or the water throughflow rate, can be varied in a manner matched to the beverage substance in the portion capsule 1, as already explained. In this case, a preparation process can also be performed by means of a plurality of portion capsules in a plurality of steps. This was described further above using the example of a cappuccino beverage.

The system comprising portion capsules which have colour codings and comprising a beverage machine which contains a colour-identification device for detecting a respective colour coding thus permits simple and reliable control of the beverage-preparation process in a manner which is largely optimally matched to the beverage to be prepared.

In the described exemplary embodiments, the colour-identification device detects the colour coding of a respective portion capsule 1 when the portion capsule is inserted into the capsule holder of the beverage machine. However, the basic idea of control of the preparation process by means of a program which is selected by means of colour coding can also be transferred to other applications. For example, in a beverage machine which has a reservoir magazine for a relative large number of portion capsules of different types, a portion capsule of a specific type can be supplied in an automated manner from the reservoir magazine to the capsule holder with the aid of colour identification. In this case, the colour-identification device can be arranged, for example, in the capsule magazine itself or in a supply channel between the capsule magazine and the capsule holder.

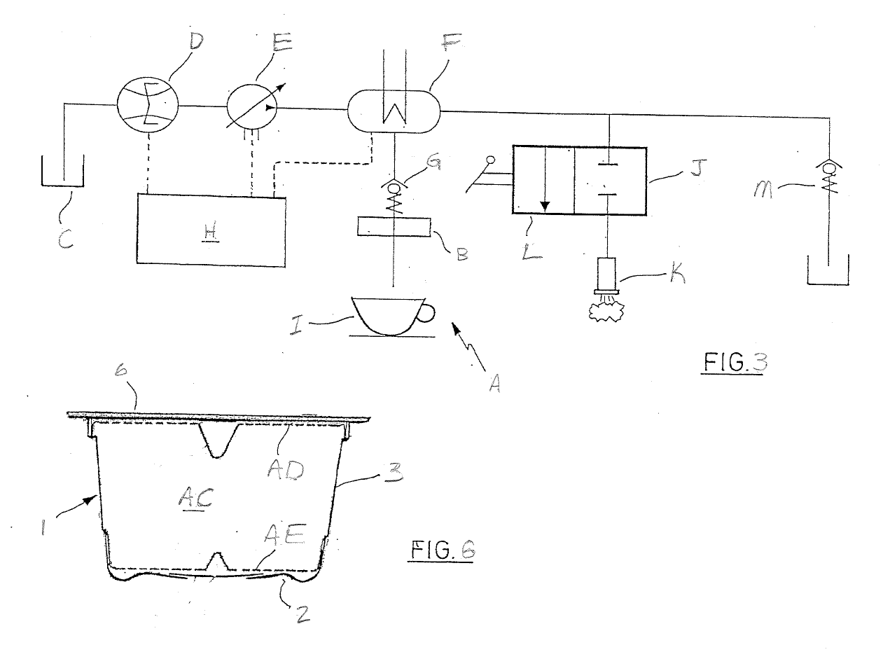

FIG. 3 is a highly schematic illustration of the coffee machine A, the functioning of the latter being explained with reference to a water-flow plan.

The coffee machine A has a portion-capsule holder B into which the portion capsule 1 (see FIG. 1) with a beverage substance (in the exemplary embodiment a coffee substance) can be inserted. As will be explained hereinbelow, openings are created in the portion capsule 1, in which case hot water can pass into the portion capsule and extracted beverage can flow out.

During operation of the coffee machine A water is taken from a water supply C and delivered via a throughflow meter D, by means of a pump E, to a boiler F. In the exemplary embodiment, the pump E is a piston pump which can build up relatively high pressures (e.g. 14 to 16 bar).

The boiler F is configured as a flow heater and has a relatively large accommodating volume (e.g. 100 ml), in order to avoid any great fluctuations in temperature. Located at the outlet of the boiler F, and above the portion-capsule holder B, is a valve G which opens at a relatively low pressure (e.g. 2 bar, less than the pressure generated by the pump E) and prevents dripping when the pump E is not in operation.

In order to control the coffee machine A, use is made of a control means H which is connected to the throughflow meter D, the pump E and the boiler F via signal and control lines. The colour-identification device 10 or 20 is suitably coupled to the control means to select a program in the control means which appropriately operates the beverage machine according to the color detected.

The user preselects the desired pressure in the operating mode for brewing a hot coffee beverage, this being done via preselection of the capacity of the pump E. For example, pressures of approximately 14 to 16 bar are suitable for brewing espresso, pressures of approximately 10 to 12 bar are suitable for brewing cafe crema and pressures of approximately 5 to 7 bar are suitable for brewing filter coffee. A portion capsule which is suitable for the respective coffee beverage is inserted into the portion-capsule holder B here.

In the exemplary embodiment, the signal of the throughflow meter D is used for regulating the volume flow of pressurized water, as was also explained in the introduction. This is because filter coffee has to be brewed with a low volume flow, otherwise it foams up, whereas, for cafe crema, it is precisely a foaming-up action which is desired, for which reason a large volume flow is used in this case. Espresso requires the highest volume flow. In the exemplary embodiment, however, there is no regulation of the volume flow for espresso; instead, the portion capsule is subjected to the full pressure of the pump E, and this establishes a volume flow in dependence on the flow resistance in the portion capsule, this depending essentially on the degree to which the coffee substance has been ground.

The hot pressurized water runs through the portion capsule and, following passage out of the portion capsule, the freshly brewed coffee beverage flows into a container positioned beneath the portion-capsule holder B, e.g. into a cup I.

In addition to the mode of operation explained above, which serves for brewing different kinds of hot coffee beverages and for which a water temperature of less than 100° C. is generated in the boiler F, the coffee machine A also permits a further mode of operation. In this case the pump E operates slowly and generates only a low excess pressure. The boiler F is heated up to above 100° C., this producing steam which can pass, via a steam valve J, out of a nozzle K located at the end of a tube component. An actuating device L serves for controlling the steam. If the nozzle K is held, for example, in a receptacle containing milk, the milk foams up and can be used, for example, as a head of foam for a coffee beverage which has just been brewed.

It is also conceivable to produce foamed milk with the aid of a portion capsule which contains milk and has been inserted into the portion-capsule holder B. In this case, hot water or steam is directed via the valve G.

A safety valve M is provided in order to limit the excess pressure generated by the pressurized-water device in the coffee machine A.

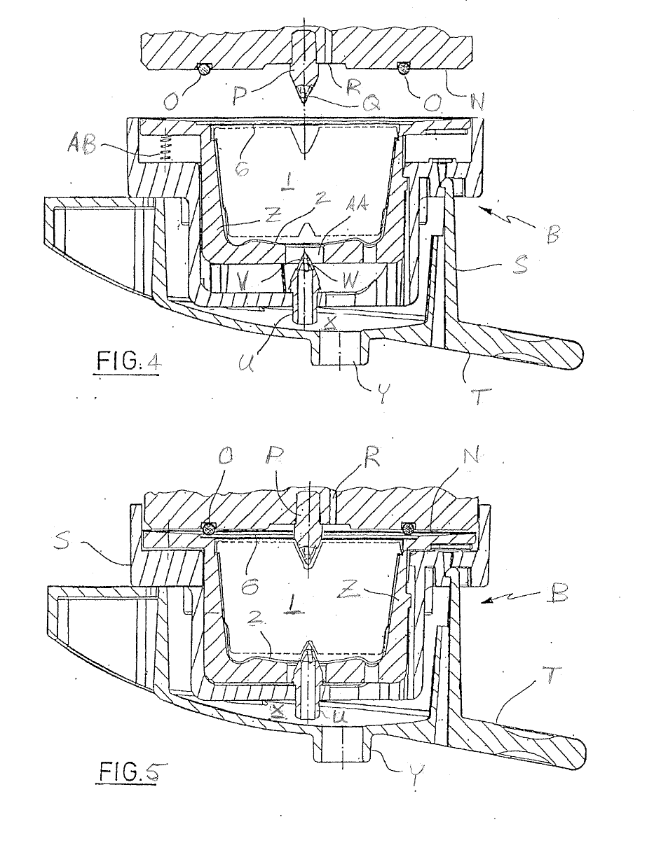

FIGS. 4 and 5 show a detailed longitudinal section through one embodiment of the portion-capsule holder B. Also illustrated is an abutment surface N which is located on the coffee machine A and is accessible from beneath. The portion-capsule holder B can be displaced upward or downward relative to the abutment surface N with the aid of a movable retaining device, which has not been depicted in the figures. FIG. 4 shows a starting position, in which the portion-capsule holder B, rather than butting against the abutment surface N, is still spaced apart therefrom. FIG. 5 illustrates the brewing state, when the portion-capsule holder B butts against the abutment surface N.

In the exemplary embodiment, it is possible for the portion-capsule holder B, in the starting position, to be removed from the abovementioned retaining device in order for a portion capsule 1 to be inserted or removed or for the portion-capsule holder B to be washed if required. In the brewing state, the retaining device is arrested with the aid of a lever.

The abutment surface N is provided with an annular groove in which an all-round seal O is arranged. The seal O butts against the periphery of the capsule cover 6 in the brewing state, see FIG. 5. From the center of the seal O, a solid spike P with a tip Q projects downward from the abutment surface N. Located alongside the spike is a water inflow R, which is connected to the boiler F via the valve G.

The portion-capsule holder B has a mount S with a handle T. A hollow spike U with a tip V, which contains a plurality of openings W, projects upward from the bottom region of the mount S. The hollow spike U opens out into a collecting chamber X, which can discharge the brewed coffee beverage outward, e.g. into a cup positioned beneath the portion-capsule holder B, via a beverage outflow Y.

The mount S guides an insert Z, which can be moved upward and downward on the mount S. The bottom region of the insert Z is provided with an opening AA which is adapted to the hollow spike U. The periphery of the insert Z is supported on the mount S via helical springs AB. In the starting position according to FIG. 4, the insert Z is thus displaced upward relative to the mount S and protects the user against being injured by the hollow spike U.

When the portion-capsule holder B is moved into the brewing position, the abutment surface N presses the insert Z downward, see FIG. 5. The spike P here passes through the capsule cover 6 of the portion capsule 1 inserted into the insert Z, while the hollow spike U penetrates the capsule base 2 as the insert Z moves downward, see FIG. 5. This applies to portion capsules with a predetermined weakening location on the capsule base 2 (e.g. for filter coffee or cafe crema), whereas a capsule base 2 without a predetermined weakening location (e.g. for espresso) is only provided with an incipient cut by the hollow spike U at this stage, see below.

Once the valve G opens in the brewing position, pressurized hot water passes through the water inflow R, and the opening in the capsule cover 6 created by the spike P, into the interior of the portion capsule 1 and is distributed in a coffee substance AC by a distributor device AD of the portion capsule 1. The prepared coffee beverage is directed to the hollow spike U by a collecting device AE of the portion capsule 1 and passes out of the coffee machine A via the collecting chamber X and the beverage outflow Y.

As has already been mentioned, in the case of the portion capsule 1 (for filter coffee or cafe crema), both the capsule cover 6 and the capsule base 2 are pierced when the portion-capsule holder B has reached the brewing position according to FIG. 5. In the case of a portion capsule for espresso, the capsule base has no predetermined weakening location and is therefore initially only provided with an incipient cut in the brewing position of the portion-capsule holder B. It is only when, following the introduction of the hot water, a pressure is built up in the interior of the portion capsule that the capsule base curves downward to the extent where the tip V of the hollow spike U can penetrate all the way through the capsule base. In the case of this configuration, the hot water remains in the interior of the portion capsule for a relatively long period of time and pressure is built up there, which may result in improved extraction and aroma-specific advantages.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A system comprising:
portion capsules of at least two different types which each contain a beverage substance; and
a beverage machine which is designed to prepare beverages, in particular to brew hot coffee beverages using the portion capsules and includes a pressurized-water device, a capsule holder which is designed to accommodate at least one of the portion capsules, and a control means,
said portion capsules of at least two different types are provided with colour codings which differ from one another,
said beverage machine including a colour-identification device which is designed to detect the colour coding of each portion capsule which is inserted into the capsule holder and to select, in the control means, a program, which is associated with this colour coding, for operating the beverage machine.

2. The system according to claim 1,
said colour-identification device including a colour sensor.

3. The system according to claim 2,
said colour-identification device including a light source which is separate from the colour sensor.

4. The system according to claim 2,
said colour-identification device including a light source which is integrated in the colour sensor.

5. The system according to claim 1,
said control means being designed to control, in accordance with the program selected by means of the colour coding, during a beverage-preparation process a variable selected from the group consisting of water pressure, water temperature, water quantity, water throughflow rate, and combinations thereof.

6. The system according to claim 1,
said control means being designed to carry out a first step of a beverage-preparation process in accordance with the program selected by means of the colour coding of a first one of the portion capsules and to carry out a second step of the beverage-preparation process in accordance with the colour coding of a second one of the portion capsules which is accommodated in the capsule holder after said first portion capsule.

7. The system according to claim 1,
said portion capsules of at least two different types are in each case closed on all sides in the delivery state and have a capsule body with a capsule base and a side wall and also a capsule cover which is fixed to the capsule body.

8. The system according to claim 7,
in the portion capsules of at least two different types, the capsule body in each case includes a circumferential, outwardly projecting flange, to which the capsule cover is fixed, at its upper end.

9. The system according to claim 7,
said colour codings of portion capsules of different types including different colours on the respective capsule bodies.

10. The system according to claim 7,
said colour codings of portion capsules of at least two different types being selected from the group consisting of different colourings, colour codes on the respective capsule covers, and a combination thereof.

11. The system according to claim 7,
said capsule base including a predetermined weakened area.

12. The system according to claim 7,
said capsule holder includes associated two piercing means which can move in relation to one another and are designed to pierce the capsule cover and the capsule base when a portion capsule is inserted into the capsule holder, so that water can pass into the capsule body through the capsule cover and beverage can pass out of the capsule body through the capsule base.

13. The system according to claim 1,
said capsule holder including a portion-capsule holding device that is removable from the rest of the beverage machine.

14. The system according to claim 1,
a portion capsule of at least one type contains a device selected from the group consisting of a distributor device above the beverage substance, a screening device beneath the beverage substance, and a combination thereof.

15. The system according to claim 1,
said beverage substance of a portion capsule of at least one type being selected from the group consisting of particulate and water-extractable beverage substances, ground coffee, ground coffee for filter coffee, ground coffee for café crema, ground coffee for espresso, decaffeinated ground coffee, instant coffee, tea, milk powder, cocoa powder, instant soups, sugar, sweetener, liquid milk, liquid milk concentrate, fruit concentrate, and combinations thereof.

16. A beverage machine which is designed to prepare beverages, in particular to brew hot coffee beverages using portion capsules provided with colour coding and which includes a pressurized-water device, a capsule holder which is designed to accommodate at least one of the portion capsules, and a control means, the improvement comprising: a colour-identification device which is designed to detect the colour coding of the at least one portion capsule inserted into the capsule holder and to select, in the control means, a program, which is associated with this colour coding, for operating the beverage machine.

17. A beverage machine according to claim 16,
said colour-identification device including a colour sensor.

18. A method for preparing a beverage, said method comprising the steps of:
inserting a portion-capsule, which is provided with a colour coding and contains a beverage substance, into a capsule holder of a beverage machine which includes a pressurized-water device and a control means;
detecting the colour coding using a colour-identification device of the beverage machine;
selecting a program, which is associated with the colour coding, for operating the beverage machine; and
operating the beverage machine by means of the control means in accordance with the selected program.

19. The method according to claim 18; and
controlling with said control means, in accordance with the program selected by means of the colour coding, during a beverage-preparation process, a variable selected from the group consisting of water pressure, water temperature, water quantity, water throughflow rate, and combinations thereof.

20. The method according to claim 18;
performing a first step of a beverage-preparation process in accordance with the program selected by means of the colour coding of a first portion capsule; and
subsequently performing a second step of the beverage-preparation process in accordance with the colour coding of a second portion capsule which is accommodated in the capsule holder after said first portion capsule.
